(19) United States
(12) Patent Application Publication
(10) Pub. No.: US 2011/0106565 A1
(43) Pub. Date: May 5, 2011

(54) Proximity-Based Task Lists

(75) Inventors: David Compton, Lenexa, KS (US); James Eaton, Gardner, KS (US); Justin Nelson, Merriam, KS (US); David Pierre, Leawood, KS (US); Matthew Sawka, Smithville, MO (US)

(73) Assignee: CERNER INNOVATION, INC., Overland Park, KS (US)

(21) Appl. No.: 12/980,497

(22) Filed: Dec. 29, 2010

Related U.S. Application Data
(63) Continuation-in-part of application No. 12/612,426, filed on Nov. 4, 2009.

(51) Int. Cl. G06Q 50/00; G06Q 10/00

(52) U.S. Cl. 705/3; 705/2

(57) ABSTRACT

Systems, methods, and computer-readable media for providing proximity-based task lists to clinicians are provided. In embodiments, a task is identified as well as a clinician that is near a location associated with the task. In addition to identifying clinicians that are near the location associated with the task, clinicians authorized to complete the task and available to complete the task are identified. If all criteria are met, a clinician may be assigned to the task and notified of the task. Additionally, a task may be reassigned to a different clinician should any of the criteria fail to be satisfied at any point.

### CROSS-REFERENCE TO RELATED APPLICATIONS

This application is a continuation-in-part of U.S. application Ser. No. 12/612,426 (Attorney Docket Number CRNI.149452) entitled “Providing Clinical Information to Clinicians,” filed on Nov. 4, 2009, the entirety of which is hereby incorporated by reference.

### BACKGROUND

Clinical integration into a paperless chart, i.e., an electronic health record (EHR), increases efficiency by allowing an up-to-date view of the EHR. Such an up-to-date view includes information regarding tasks that are input by clinicians, consultations requested by clinicians, test results, status updates for tasks, and the like. Computing devices may notify clinicians, non-clinicians, patients, family members, or the like of clinical events. Clinical events include, but are not limited to, non-invasive procedures, surgical procedures, tests, evaluations, examinations, consultations, patient transports, or the like.

Clinicians are often waiting on clinical events, or notifications thereof, to create a treatment plan. For example, a clinician may wait on a test result before ordering further treatment. Clinicians may also wait on notification of clinical events to take action. For instance, a nurse may rely on a task list to organize what actions should be taken throughout a shift.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The present invention relates to computing environments. More particularly, embodiments of the present invention relate to methods for use in, e.g., a patient care computing environment. Further embodiments of the present invention relate to a mobile device for providing clinical information to clinicians in accordance with one or more of the described methods.

In one embodiment, a set of computer-useable instructions providing a method for providing clinical information to clinicians is illustrated. The method includes identifying in a patient's electronic health record that a first clinician treating the patient has requested a consult with a second clinician treating the patient. The location of both the first clinician and the second clinician is received by way of a first clinician identifier and a second clinician identifier that is tracked via a plurality of sensors in a healthcare environment. A determination is made whether the location of both the first clinician and the second clinician are near one another. The determination is based on the proximity of the sensors that identified the location of both the first and the second clinician. Based upon a determination that the location for the first clinician and the location for the second clinician are near one another, a notification is presented to the first clinician that includes the location of the second clinician.

In another embodiment, a set of computer-useable instructions providing a method for providing clinical information to clinicians is illustrated. An indication is received that a first clinician has input a task for a patient. One or more tangible items are determined to fulfill the task. Upon determining one or more tangible items to fulfill the task, a location for each of the one or more tangible items to fulfill the task is determined. A second clinician is notified of the task and a location of the tangible item to fulfill the task. The location of the one or more tangible items is the location of the tangible item that is nearest to the second clinician. The second clinician is routed to the location of the tangible item to fulfill the task.

In another embodiment, a set of computer-useable instructions providing a method for providing clinical information to clinicians is illustrated. An indication is received that a healthcare code is in effect for a patient. The location of the patient is determined and clinician location information is accessed. The locations of both the patient and the clinicians are based on a patient identifier and clinician identifiers that are identified by a plurality of sensors in the healthcare environment. Based on the clinician location information, the nearest clinician to the location of the patient is determined. An alert is presented to the nearest clinician that the code is in effect for the patient.

In another embodiment, a set of computer-useable instructions providing a method for providing clinical information to clinicians is illustrated. A first task ordered for a patient is identified. A location for the patient is received and a first clinician that is near the location of the patient is identified. A determination is made whether the first clinician is authorized to complete the first task. Upon determining that the first clinician is authorized to complete the task, the first task is assigned to the first clinician. A notification of the first task is presented to the first clinician. The notification includes an option to receive navigation to the location for the patient.

In another embodiment, a set of computer-useable instructions providing a method for providing clinical information to clinicians is illustrated. An indication that a clinician has input a task for a patient is received. One or more clinicians that are near the patient are identified and a determination is made whether the any of the clinicians are authorized to perform the task. Upon determining that a first clinician is authorized to perform the task, assigning the task to the first clinician. A workload update is received from the first clinician and a determination is made whether the workload update requires that the task be reassigned to a second clinician. Upon determining that the workload update requires that the task be reassigned to the second clinician, the task is reassigned to the second clinician. The second clinician is notified of the task and a location to complete the task. The second clinician is then routed to the location to complete the task.

In yet another embodiment, a set of computer-useable instructions providing a method for providing clinical information to clinicians is illustrated. A first upcoming task is identified for a patient and a location of the patient is identified. Clinician location information is accessed so that a clinician nearest to the location of the patient is identified. A determination whether the patient is associated with one or more additional upcoming tasks is made an, upon determining that the patient is associated with one or more additional upcoming tasks, both the first upcoming task and the one or more additional upcoming tasks are assigned to the clinician nearest the location of the patient. A notification is presented to the clinician that the first upcoming task and the one or more additional upcoming tasks are required for the patient.

Additional objects, advantages, and novel features of the invention will be set forth in part in the description which follows, and in part will become apparent to those skilled in the art upon examination of the following, or may be learned by practice of the invention.

### BRIEF DESCRIPTION OF THE DRAWING

The present invention is described in detail below with reference to the attached drawing figures, wherein:

FIG. 1 is a block diagram of an exemplary computing environment suitable for use in implementing the present invention;

FIG. 2 is an illustrative graphical user interface display of an electronic health record being accessed and reviewed, in accordance with embodiments of the present invention;

FIG. 3 is a flow diagram illustrating a first exemplary method for providing clinical information to clinicians, in accordance with embodiments of the present invention;

FIG. 4 is an illustrative graphical user interface display of a notification that a clinician is near a second clinician, in accordance with embodiments of the present invention;

FIG. 5 is a flow diagram illustrating a second exemplary method for providing clinical information to clinicians, in accordance with embodiments of the present invention;

FIG. 6 is a flow diagram illustrating a third exemplary method for providing clinical information to clinicians, in accordance with embodiments of the present invention;

FIG. 7 is a flow diagram illustrating a fourth exemplary method for providing clinical information to clinicians, in accordance with embodiments of the present invention;

FIG. 8 is a flow diagram illustrating a fifth exemplary method for providing clinical information to clinicians, in accordance with embodiments of the present invention; and

FIG. 9 is a flow diagram illustrating a sixth exemplary method for providing clinical information to clinicians, in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

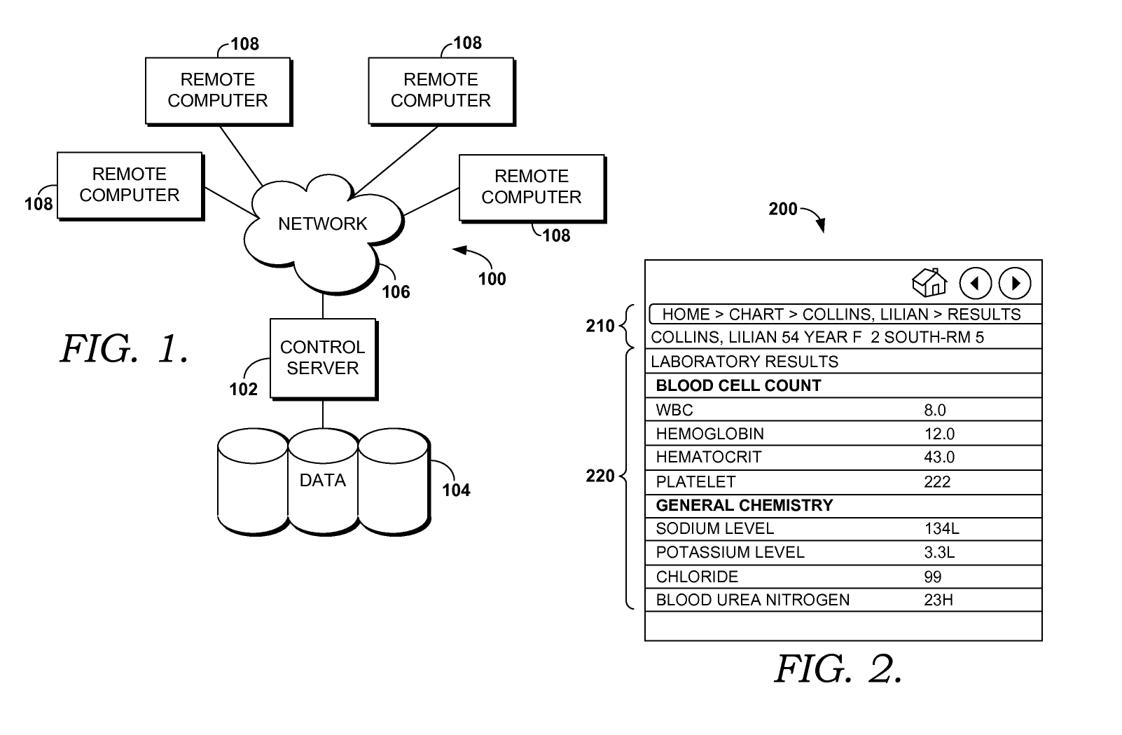

Referring now to the drawings in general, and initially to FIG. 1 in particular, an exemplary computing system environment, for instance, a medical information computing system, on which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the medical information computing system environment 100 be interpreted as having any dependency or requirement relating to any single component or combination of components illustrated therein.

Embodiments of the present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

Embodiments of the present invention may be described in the general context of computer-executable instructions, such as program modules, being executed by a computer. Generally, program modules include, but are not limited to, routines, programs, objects, components, and data structures that perform particular tasks or implement particular abstract data types. Embodiments of the present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 100 includes a general purpose computing device in the form of a server 102. Components of the server 102 may include, without limitation, a processing unit, internal system memory, and a suitable system bus for coupling various system components, including database cluster 104, with the server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 102 typically includes, or has access to, a variety of computer readable media, for instance, database cluster 104. Computer readable media can be any available media that may be accessed by server 102, and includes volatile and nonvolatile media, as well as removable and non-removable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 22. Communication media typically embodies computer readable instructions, data structures, program modules, or other data in a modulated data signal, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 104, provide storage of computer readable instructions, data structures, program modules, and other data for the server 102.

The server 102 may operate in a computer network 106 using logical connections to one or more remote computers 108. Remote computers 108 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 28 may also be physically located in non-traditional medical care environments so that the entire health care community may be capable of integration on the network. The remote computers 108 may be personal computers, servers, routers, network PCs, mobile phones, peer devices, other common network nodes, or the like, and may include some or all of the components described above in relation to the server 102. The devices can be personal digital assistants or other like devices.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the server 102 may include a modem or other means for establishing communications over the WAN, such as the Internet. In a networked environment, program modules or portions thereof may be stored in the server 102, in the database cluster 104, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., server 102 and remote computers 108) may be utilized.

In operation, a user may enter commands and information into the server 102 or convey the commands and information to the server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 102. In addition to a monitor, the server 102 and/or remote computers 108 may include other peripheral output devices, such as speakers and a printer.

Although many other internal components of the server 102 and the remote computers 108 are not shown, those of ordinary skill in the art will appreciate that such components and their interconnections are well known. Accordingly, additional details concerning the internal construction of the server 102 and the remote computers 108 are not further disclosed herein.

In accordance with embodiments of the present invention, a clinician may input a task relating to a particular patient into a computing device, such as exemplary remote computer 108 illustrated in FIG. 1. The computing device may be any device that is capable of receiving and/or presenting tasks. Accordingly, the computing device may take on a variety of forms, such as a laptop computer, a mobile phone, a personal digital assistant (PDA), a server, or any other device that is capable of receiving and/or presenting tasks. Clinicians include, but are not limited to, the treating physician, specialists such as surgeons, radiologists and cardiologists, emergency medical technicians, physician's assistants, nurse practitioners, nurses, nurse's aides, pharmacists, dieticians, microbiologists, laboratory experts, genetic counselors, researchers, veterinarians, students and the like. In an embodiment, a clinician is any user that is authorized to input a task for a patient.

A task, as used herein, is an item that was or is to be done for a particular patient. Tasks may include, for example, administering a medication, monitoring vital signs, collecting data, performing a procedure and/or a test, transporting a patient, maintaining equipment, or the like.

Once a clinician inputs a task, a clinician assigned to the task, as well as various other clinicians may need to be notified of the existence of the task. For instance, assume Dr. Howard inputs a task for Patient Sue to have her vital signs monitored every hour. Another clinician, e.g., Patient Sue's nurse, needs to know that Patient Sue must be monitored hourly. Additionally, the clinician that input the order may want to be notified when the order is completed. Thus, the computing device presents a notification to Patient Sue's nurse regarding the task. The notification may be an audible notification, a visual notification, a combination of an audible and a visual notification, or the like. The notification may, alternatively, be presented to any clinician associated with the patient of the task. Since clinicians may receive numerous notifications a day, the computing device may be programmed such that urgent notifications are presented in one manner (e.g., a tone or a vibration) while notifications that are not as urgent are presented in another manner (e.g., a flashing light). In an embodiment, tasks are assigned to a clinician based on location, among other things, as will be discussed below.

In addition to being notified of an existing task, clinicians may also require status updates regarding a task. The computing device may present status notifications to the clinician that input the task or any other relevant clinician. By way of example only, a clinician may be notified that the task is pending, acknowledged, completed, or the like.

When results are associated with the task, the clinician may have the option to review the results, as illustrated in FIG. 2. FIG. 2 illustrates an illustrative graphical user interface display 200 of an electronic health record being accessed and reviewed. The interface 200 includes a medical record identifier 210 that identifies a patient, a patient location, and the like. The interface 200 further includes test results 220 that may be related to an input task. The test results 220 may be retrieved directly from the patient's EHR and displayed on a computing device. Additional information retrieved from an EHR may include a consultation request from a requesting clinician to seek a consult with a requested clinician.

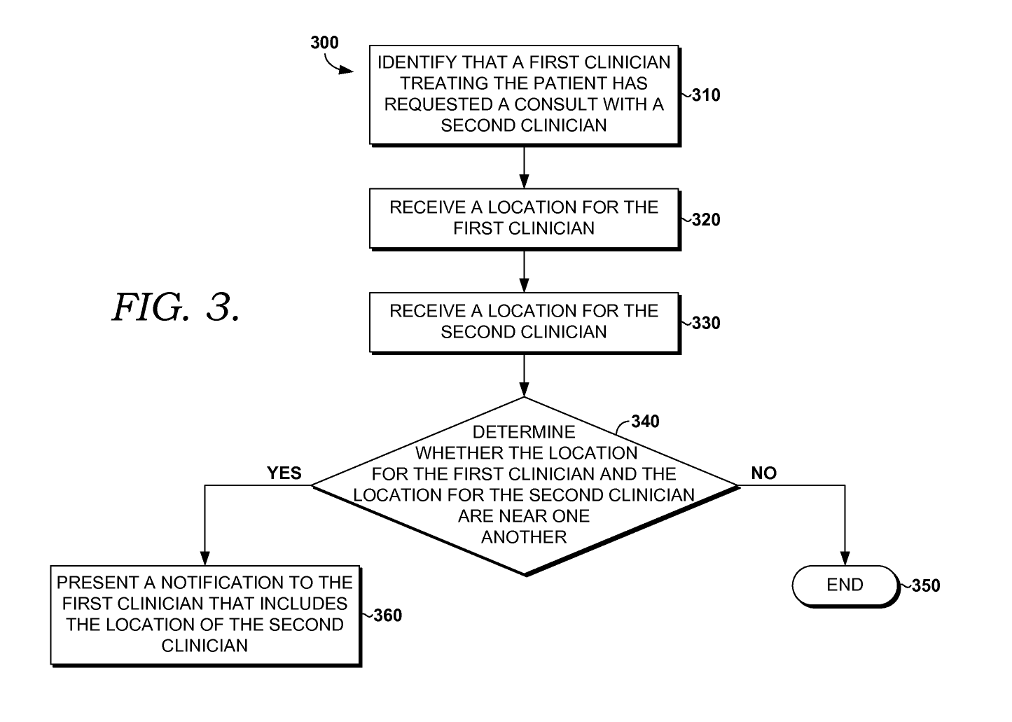

Turning now to FIG. 3, a first exemplary method 300 for providing clinical information to clinicians is illustrated. It is identified in a patient's EHR that a first clinician (i.e., the requesting clinician) treating the patient has requested a consult with a second clinician (i.e., the requested clinician) at block 310. Clinicians often request consults with other clinicians in order to obtain a second opinion, seek guidance of a specialist, or the like.

A location for the first clinician is received at block 320 and a location for the second clinician is received at block 330. Clinician location information is monitored via clinician identifiers. Clinician identifiers may take the form of a security badge, an item attached to a security badge, or the like. The clinician identifiers are tracked by way of sensors located in the healthcare environment. The sensors may utilize a real-time location services technology such as ultrasound technology, infrared technology, radio-frequency identification (RFID) technology, or the like. Using said technology, the sensors send out signals to identifiers. An exemplary sensor system is the Cricket Indoor Location System sponsored by the MIT Project Oxygen partnership.

The signals are received by the identifiers and the identifiers respond to the signals. A response from an identifier is received by the sensors and the sensors are able to recognize and determine the location of the responding identifier. When a clinician identifier is identified by a sensor, the location for the clinician associated with the clinician identifier is updated. At block 340, a determination is made whether the location for the first clinician and the location for the second clinician are near one another. The determination is based on the proximity of the sensors that identified the location of both the first clinician and the second clinician. For example, the location of the sensors may be presented on the computing device via a blueprint of the healthcare environment. If Clinician 1 and Clinician 2 are identified by a sensor, their respective locations will be presented on the computing device. The computing device may access the actual location of the sensors within the healthcare environment and the distance between the sensors. Thus, the computing device is able to identify the sensors associated with the respective locations of Clinician 1 and Clinician 2 and determine whether the clinicians are near one another. The phrase “near one another,” as used herein, generally refers to a pre-defined distance or proximity between two clinicians or any other individual and/or item associated with an identifier. A user may define “near one another” to be any variable that is appropriate for their use. For instance, a user may define being near one another as being on the same floor of a healthcare facility while another user may define being near one another as being on the same wing of a healthcare facility. Further examples of being near one another may include actual distance, e.g., 200 feet from one another.

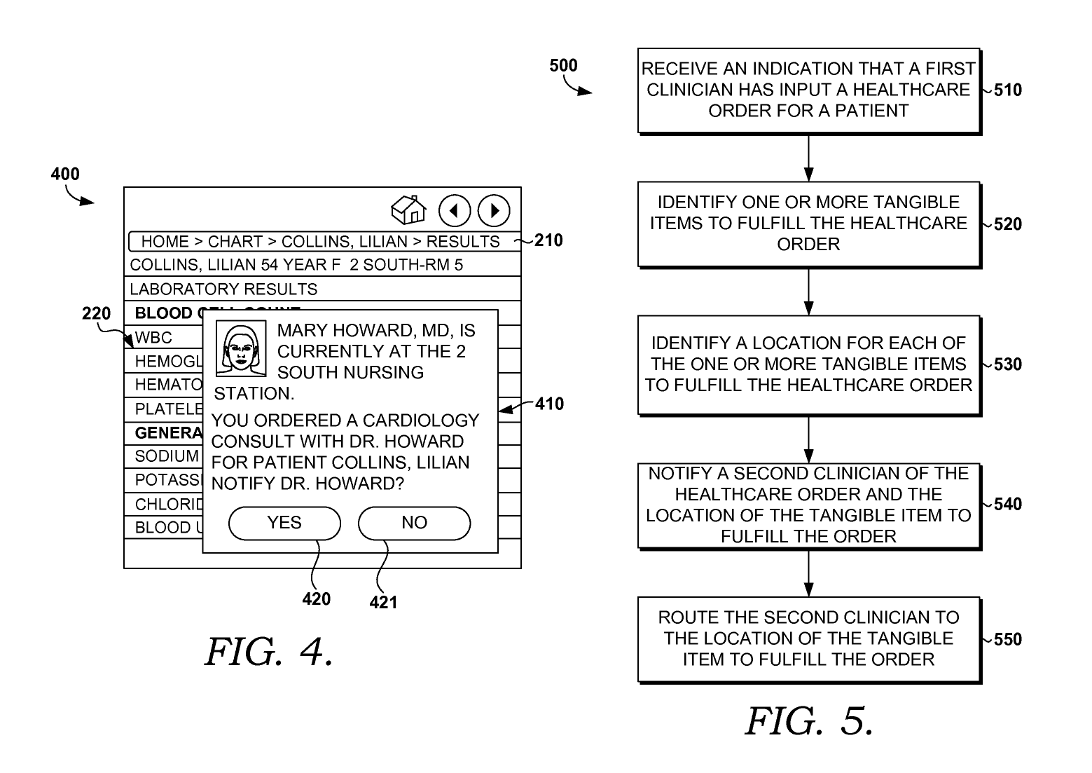

Upon a determination that the location for the first clinician and the location for the second clinician are not near one another, the method ends at block 350. Upon a determination that the location for the first clinician and the location for the second clinician are near one another, a notification is presented to the first clinician that includes the location of the second clinician at block 360. An exemplary notification is illustrated in FIG. 4.

An illustrative user interface 400 may display test results 220 to a clinician and still present a notification 410. Notification 410 is presented to the clinician that Dr. Howard is nearby. Notification 410 may include the location for Dr. Howard (i.e., the requested or second clinician). Notification 410 may also include an affirmative indicator 420 and a negative indicator 421. Both the affirmative indicator 420 and the negative indicator 421 may be selected to indicate whether the clinician viewing the notification would like to inform the requested clinician, in this case, Dr. Howard, of their location. Such clinical integration makes it easier to identify clinicians' needs and facilitates communication between clinicians at convenient times. Less time is wasted tracking down colleagues since clinicians may be notified when their location is near that of a relevant clinician.

When the viewing clinician selects the affirmative indicator 420, a notification is presented to the requested clinician that includes the location of the viewing clinician. A selection of the affirmative indicator 420 also results in a date stamp and a time stamp of the selection such that the date and time of the notification is saved for reference. When the viewing clinician selects the negative indicator 421, a notification is not presented to the requested clinician at that time. A date stamp and a time stamp may still be applied to the notification and saved in a database for reference.

In embodiments, the second clinician (i.e., the requested clinician) may be near the patient rather than near the first clinician. By way of example only, if Dr. Smith requested a consultation with Dr. Howard regarding Patient Ben and Dr. Howard is determined to be near Patient Ben, a notification will be sent to Dr. Smith such that Dr. Howard's proximity to the patient is known and an opportunity for the consultation is not lost.

A patient location is tracked in the same way as clinician location information. A patient identifier is associated with a patient and is identified by the plurality of sensors in the healthcare environment. The patient identifier may be a badge, a wristband, or any other method of monitoring the location of a person.

In other embodiments, a clinician may input a task into an EHR that requires one or more tangible items to complete the task. Many tasks require one or more tangible items in order to be completed. For example, a task to shave a patient requires a razor, shaving cream, a towel, and the like.

With reference to FIG. 5, a second exemplary method 500 for providing clinical information to clinicians is illustrated. An indication that a first clinician has input a task for a patient is received at block 510. At block 520, one or more tangible items required to complete the task are identified.

Tasks requiring tangible items to be completed may be completed more efficiently when the required tangible item is easily located. Thus, at block 530 a location for each of the one or more tangible items required to complete the task is identified. Tangible items, much like clinicians and patients, may be tracked via item identifiers. Item identifiers are similar to clinician and patient identifiers in that they are tracked by way of the sensors located in the healthcare environment. The item identifiers may be tags on the items or any other method of monitoring the location of an item using the sensors.

When a location of the one or more tangible items required to complete the task is identified, a second clinician is notified of both the task and the location of the one or more tangible items required to complete the task at block 540. The second clinician may be a clinician associated with the patient, a clinician near the patient, a clinician identified to handle a particular task, or the like.

The location of the one or more tangible items required to complete the task may be presented to the second clinician via a blueprint of the healthcare environment. Thus, the nearest tangible item will be easily identified relative to the location of the second clinician, also tracked by the sensors by way of a clinician identifier. The nearest tangible item may also be determined relative to the location of the patient rather than to the location of the clinician.

The second clinician is then routed to the location of the one or more tangible items to complete the task at block 550. The directions to route the second clinician may be provided via a mobile computing device, such as a mobile phone. The directions may be presented using the blueprint of the healthcare environment, a list of turn-by-turn instructions, or a combination thereof. The second clinician may be routed to the nearest one or more tangible items to complete the task or, alternatively, the clinician may select a tangible item that is not illustrated as the nearest tangible item to complete the task.

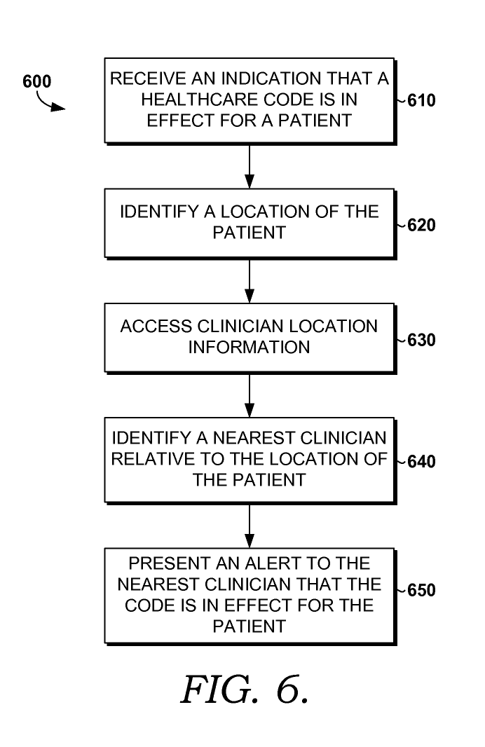

With reference to FIG. 6, a third exemplary method 600 for providing clinical information to clinicians is illustrated. At block 610, an indication that a healthcare code is in effect for a patient is received. A location of the patient is identified at block 620. As previously explained, patients may be tracked in the same way as clinicians or tangible items. Patients may be associated with a patient identifier, which may be any mechanism that may be tracked via sensors in the healthcare environment.

Clinician location information is accessed at block 630. The location of each clinician is identified within the blueprint of the healthcare environment. Once clinician information is accessed, a nearest clinician relative to the location of the patient is identified at block 640. An alert is presented to the nearest clinician that the code is in effect for the patient at block 650. Such identification of a nearest clinician relative to a coding patient utilizes resources effectively to respond quickly to a coding patient. The alert may be an audible alert, a visual alert, a combination of an audible and a visual alert, or the like. The computing device presenting the alert may be programmed such that urgent alerts, such as a coding patient, are presented in one manner (e.g., a tone or a vibration) while alerts that are not as urgent are presented in another manner (e.g., a flashing light).

In addition to notifying a clinician of an alert based on location, a clinician may also be notified of a task that has been assigned to them based on location, among other things. Tasks may be pushed to clinicians based on location, authorization, workload, and the like. The task may be assigned and pushed to the clinician based on their location, which may be based on a proximity to a patient location of a patient associated with the task or a location associated with completion of the task. For instance, a first clinician may input a task to administer an IV to a patient. Rather than indicating a specific clinician to perform the task, the task may be assigned to a second clinician that is near the patient, thus maximizing efficiency. Accordingly, a second clinician that is determined to be near the patient (or near the location to complete the task) may be assigned to the task input by the first clinician. Once assigned, the second clinician may receive a notification thereof. The notification may be similar to the notification 410 provided in FIG. 4. In an embodiment, the clinician is able to view their entire task list that has been organized based on location such that a clinician is able to easily identify tasks that require completion. In an alternate embodiment, a clinician may access a patient-specific task list such that all tasks for a patient are readily available.

By way of further example, assignment of tasks based on location may be very effective regarding transportation of patients. Assume that Patient A is being transported to 3 West and a new task has been input for Patient B (currently on 3 West) to be transported to the laboratory. It would be efficient for the same clinician that is transporting Patient A to transport Patient B from 3 West since the clinician will already be on 3 West for the transport of Patient A.

Tasks may also be assigned based on authorization to complete the task. A task may, for instance, require a specific skill set for completion. For example, a student may not be authorized to perform certain tasks. Further, a transporter is not authorized to perform the same tasks as a nurse. Thus, once clinicians associated with locations that are near a location associated with the task are identified, clinicians that are not authorized to perform the task may be filtered out such that they are no longer an option to assign to the task.

By way of example only, a task to transport a patient may be associated with the patient's current location. A plurality of clinicians may then be identified as being near the patient's current location. However, some of the clinicians that are near the patient's current location may not be authorized to transport the patient for various reasons (e.g., a critical patient may require a specific transporter). The clinicians that are not authorized to transport the patient may be filtered out. Thus, only clinicians that are near the patient's current location and that are authorized to transport the patient remain as options to assign to the task.

Tasks may be further assigned to clinicians based on workloads of the clinicians. A workload, as used herein, refers generally to an amount of work that is currently assigned to a clinician. For instance, two clinicians may each be assigned to five patients but one of the clinicians may have two patients that require more care than any of the others. Thus, the clinician with the critical patients may be associated with a greater workload than that of the other clinician.

When assigning tasks to clinicians, the workload may be taken into account such that a clinician is not overloaded. The workload of a clinician may be considered once authorized clinicians that are near the patient are identified. Alternatively, the workload of the clinician may be considered prior to location and authorization. Accordingly, criteria for assigning tasks to caregivers may be considered in any order.

Tasks may be reassigned to different clinicians based on any of the above criteria, as well as updates of the above criteria. For instance, assume that an administration of medication is due for Patient A and Nurse 1 walks by Patient A's room. The task to administer the medication may be reassigned to Nurse 1, as Nurse 1 is the nearest clinician. Additionally, if a task is currently assigned to Clinician 1 but Clinician 1 has also recently assumed duties for two critical patients, the task may be reassigned to another clinician upon receiving an updated workload for Clinician 1.

By way of further example, a task may be assigned to a first clinician. The task may have been assigned to the first clinician based on one or more of location, authorization, or workload. Once tasks are assigned to clinicians, a status of the clinician may be monitored. For example, if a location of a clinician changes, a location update is received. If a workload of a clinician changes, a workload update is received. The updates may require that the task be reassigned. An update requires that a task be reassigned when the update indicates it is not optimal for a clinician to be assigned to the task. For instance, if a workload update indicates that a clinician is overloaded, a task may be reassigned. If a location update indicates that the clinician is no longer located near a location associated with the task, the task may be reassigned.

In an additional embodiment, tasks may be generated for equipment, as well as patients. For example, an item of equipment may require maintenance or may have been recently recalled and require removal. A task may be generated to provide maintenance to the equipment or remove the equipment. Once generated, the task for the equipment may be assigned based on the same criteria outlined above (e.g., location, authorization, workload, etc.).

Once the task has been assigned, or reassigned, to a clinician, the clinician may desire to receive directions to a location associated with the task. By way of example only, the task may require that a piece of recalled equipment be removed from the healthcare environment. A location of the recalled equipment may be provided to the clinician, as well as directions to the location of the recalled equipment. The directions may be provided to the clinician in a blueprint of the healthcare environment, a list of turn-by-turn directions, images of the healthcare environment, or a combination thereof, as described in detail herein.

In addition to the above-described embodiments, the computing device utilized for the present invention may perform other functions to optimize the clinical experience. Navigational directions of a healthcare environment are accessible to a user, as described above, and points of interest and directions thereto may also be identified and presented on the computing device. A point of interest is a location external to that of the healthcare environment. For example, a user may need to find a nearby bank, restaurant, pharmacy, or the like. The computing device, once activated to perform the present invention, will identify a desired point of interest and present directions that route the user to the point of interest.

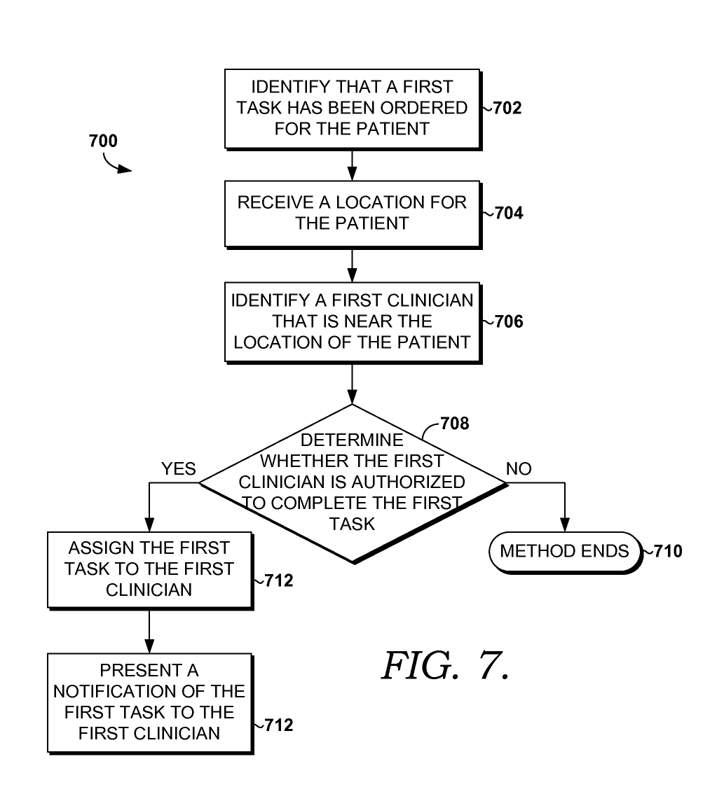

Turning now to FIG. 7, a fourth exemplary method 700 for providing clinical information to clinicians is illustrated. Initially, at block 702, a first task that has been ordered for a patient is identified. The task may be identified from a patient's EHR. At block 704 a location for the patient is received. The location for the patient may be received utilizing patient identifiers that are tracked via a plurality of sensors. At block 706 a first clinician that is near the location of the patient is identified. At block 708 a determination is made whether the first clinician is authorized to complete the first task. If not, the method ends at block 710. Based upon a determination that the first clinician is authorized to complete the first task, the first task is assigned to the first clinician at block 712. A notification of the first task is presented to the first clinician at block 714.

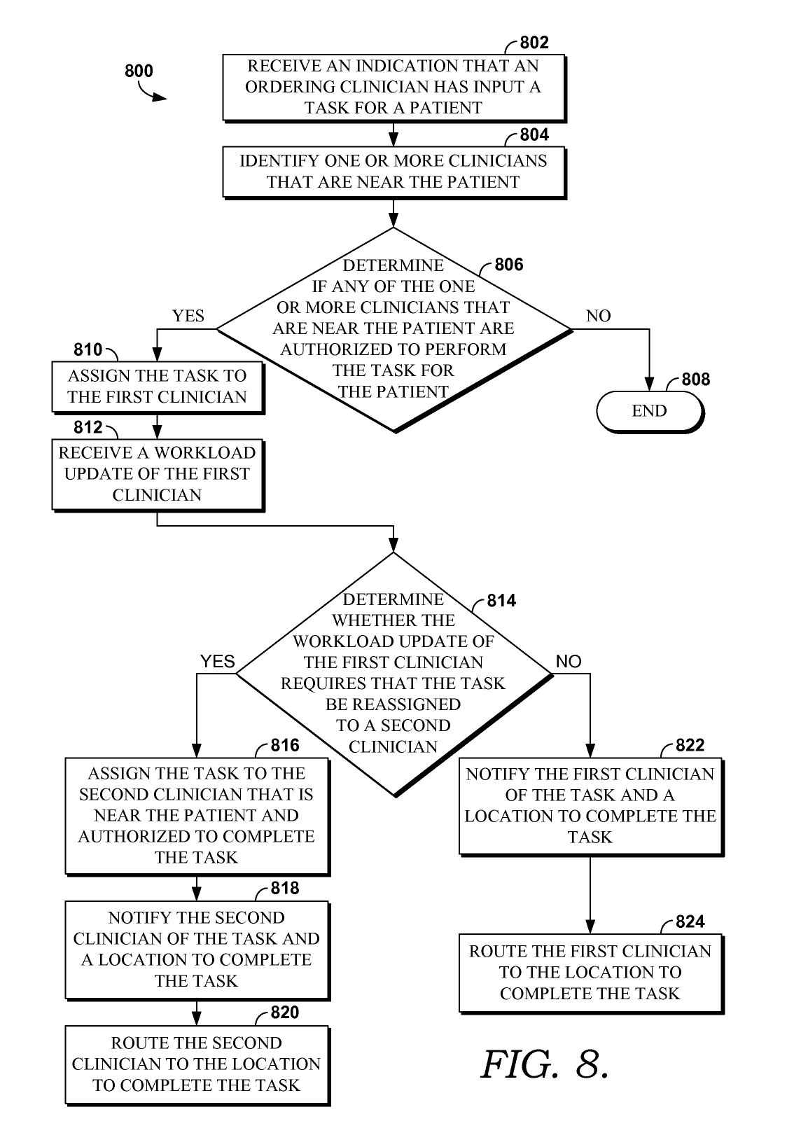

Turning now to FIG. 8, a fifth exemplary method 800 for providing clinical information to clinicians is illustrated. Initially, at block 802, an indication that an ordering clinician has input a task for a patient is received. One or more clinicians near the patient are identified at block 804 and a determination is made whether any of the one or more clinicians are authorized to perform the task for the patient at block 806. If none of the one or more clinicians are authorized to perform the task for the patient, the method ends at block 808. Based upon determining that a first clinician of the one or more clinicians is authorized to perform the task for the patient, the task is assigned to the first clinician at block 810. A workload update is received for the first clinician at block 812 and a determination is made at block 814 whether the workload update requires that the task be reassigned to a second clinician. Based on a determination that the workload updated requires that the task be reassigned, the task is reassigned to a second clinician at block 816. The second clinician is notified of the task and a location to complete the task at block 818 and is routed to the location to complete the task at block 820.

Based on a determination that the workload updated does not require that the task be reassigned, the task is assigned to the first clinician and the first clinician is notified of the task at block 822. The first clinician is then routed to the location to complete the task at block 824.

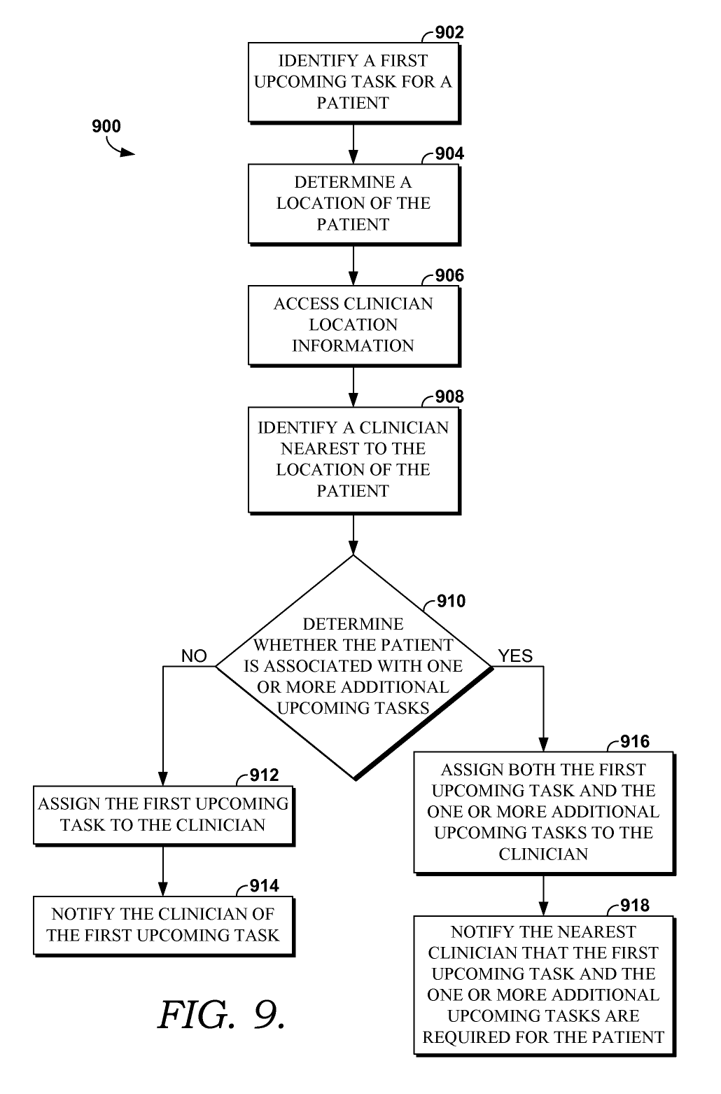

Turning now to FIG. 9, a sixth exemplary method 900 for providing clinical information to clinicians is illustrated. Initially, at block 902, a first upcoming task for a patient is identified and a patient location is identified at block 904. Clinician location information is accessed at block 906 and a clinician nearest to the location of the patient is identified at block 908. At block 910 a determination is made whether the patient is associated with one or more additional upcoming tasks. Based upon a determination that the patient is not associated with one or more additional upcoming tasks, the first upcoming task is assigned to the clinician at block 912 and the clinician is notified of the first upcoming task at block 914. Based on a determination that the patient is associated with one or more additional upcoming tasks, the first upcoming task and the one or more additional upcoming tasks are assigned to the clinician nearest to the location of the patient at block 916. The clinician is then notified of the first upcoming task and the one or more additional upcoming tasks at block 918.

As can be understood, the present invention provides computer-storage media, systems, and methods for providing clinical information to clinicians. Embodiments of the present invention may also provide computer-storage media, systems, and methods for optimizing a clinical experience.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

Having thus described the invention, what is claimed is:

1. One or more computer-storage media having computer-useable instructions embodied thereon that, when executed, perform a method, the method comprising:
identifying in a patient's electronic health record that a first task has been ordered for the patient;
receiving a location for the patient by way of a patient identifier, wherein the patient identifier is tracked via a plurality of sensors in a healthcare environment;
identifying a first clinician that is near the location of the patient, wherein the first clinician is determined to be near the location of the patient utilizing the plurality of sensors in the healthcare environment;
determining whether the first clinician is authorized to complete the first task;
upon determining that the first clinician is authorized to complete the first task, assigning the first task to the first clinician; and
presenting a notification of the first task to the first clinician, wherein the notification includes an option to receive navigation to the location for the patient.

2. The computer-storage media of claim 1, wherein the method further comprises:
presenting the notification to the first clinician via a mobile device.

3. The computer-storage media of claim 1, wherein the method further comprises:
presenting navigational directions to the first clinician.

4. The computer storage media of claim 3, wherein the navigations directions are one of a list of turn-by-turn directions, a blueprint of the healthcare environment, or a combination thereof.

5. The computer-storage media of claim 4, wherein the method further comprises:
determining if a workload of the first clinician allows the first clinician to be assigned to the first task.

6. The computer-storage media of claim 1, wherein the plurality of sensors utilize a real-time location services technology.

7. The computer-storage media of claim 1, wherein the notification is an audio notification.

8. The computer-storage media of claim 1, wherein the method further comprises presenting status updates of a task via a mobile device.

9. The computer-storage media of claim 1, further comprising presenting a patient-specific task list to the first clinician, wherein the patient-specific task list includes one or more tasks that have been ordered for the patient.

10. One or more computer-storage media having computer-useable instructions embodied thereon that, when executed, perform a method, the method comprising:
receiving an indication that an ordering clinician has input a task for a patient;
identifying one or more clinicians that are near the patient;
determining if any of the one or more clinicians that are near the patient are authorized to perform the task for the patient;
upon determining that a first clinician of the one or more clinicians that are near the patient is authorized to perform the task for the patient, assigning the task to the first clinician;
receiving a workload update of the first clinician;
determining whether the workload update of the first clinician requires that the task be reassigned to a second clinician that is near the patient and authorized to complete the task;
upon determining the workload update of the first clinician requires that the task be reassigned to the second clinician, assigning the task to the second clinician;
notifying the second clinician of the task and a location to complete the task; and
routing the second clinician to the location to complete the task.

11. The computer-storage media of claim 10, wherein the method further comprises:
presenting the location to complete the task on a mobile device with a screen.

12. The computer-storage media of claim 11, wherein the location to complete the task is presented on a blueprint of a healthcare environment.

13. The computer-storage media of claim 10, wherein routing the second clinician to the location to complete the task includes providing turn-by-turn instructions in combination with a blueprint of a healthcare environment.

14. The computer-storage media of claim 10, wherein the location to complete the task is identified by a plurality of sensors within a healthcare environment.

15. The computer-storage media of claim 14, wherein the plurality of sensors utilize a real-time location services technology.

16. One or more computer-storage media having computer-useable instructions embodied thereon that, when executed, perform a method, the method comprising:
identifying a first upcoming task for a patient;
determining a location of the patient, wherein the location of the patient is determined based on a patient identifier that is identified by one of a plurality of sensors in the healthcare environment;
accessing clinician location information, wherein clinician location information is obtained via clinician identifiers that are identified by the plurality of sensors in the healthcare environment;
identifying a clinician nearest to the location of the patient;
determining whether the patient is associated with one or more additional upcoming tasks;
upon determining that the patient is associated with one or more additional upcoming tasks, assigning both the first upcoming task and the one or more additional upcoming tasks to the clinician nearest to the location of the patient;
displaying a notification to the nearest clinician that the first upcoming task and the one or more additional upcoming tasks are required for the patient, wherein the notification includes a selectable navigation indicator that, upon selection thereof, routes the nearest clinician to a location to complete the first upcoming task and the one or more additional upcoming tasks.

17. The computer-storage media of claim 16, wherein the notification is presented to the nearest clinician via a mobile device with a screen.

18. The computer-storage media of claim 16, wherein the nearest clinician is a clinician associated with a clinician location that is near the location of the patient.

19. The computer-storage media of claim 16, wherein the method further comprises:
presenting the clinician with the location to complete the tasks via a mobile device by way of a blueprint of a healthcare environment.

20. The computer-storage media of claim 16, wherein the plurality of sensors utilize one of ultrasound technology, infrared technology, or radio-frequency identification technology.
